(19) United States
(12) Patent Application Publication
(10) Pub. No.: US 2012/0106139 A1
(43) Pub. Date: May 3, 2012

(54) ELECTRO-OPTICALLY SWITCHABLE SYSTEM

(75) Inventors: Bastian Ewald, Ludwigshafen (DE); Dirk Gerhard, Mannheim (DE); Hartmut Hibst, Schriesheim (DE)

(73) Assignee: BASF SE, Ludwigshafen (DE)

(21) Appl. No.: 13/382,583

(22) PCT Filed: Jul. 6, 2010
(86) PCT No.: PCT/EP10/59659

§ 371 Date: Jan. 6, 2012

(30) Foreign Application Priority Data
Jul. 7, 2009 (DE) 10 2009 032 073.3

(51) Int. Cl. F21V 33/00; G02F 1/163; G02F 1/1347; G02F 1/1334; G02F 1/01; G02F 1/13

(52) U.S. Cl. 362/154; 359/245

(57) ABSTRACT

An electro-optically switchable system that includes an optically active element and a momentary switch, a container that includes such an electro-optically switchable system and use of such an electro-optically switchable system for providing containers that allow increased light to pass through into the interior thereof only for the duration of a control intervention.

The present invention relates to an electro-optically switchable system which comprises an optically active element and a momentary switch, to a container which comprises such an electro-optically switchable system and to the use of such an electro-optically switchable system for providing containers that allow increased light to pass through into the interior thereof only for the duration of a control intervention.

It is known that the mechanical, chemical and/or esthetic properties of materials are often impaired irreversibly under the sustained effect of light, optionally in combination with oxygen and/or heat. This applies in particular to inanimate organic materials, which are often particularly sensitive to light. Not only openly accessible products but also products packed in light-permeable packagings are exposed to the effect of light, which can lead to the mechanical, chemical, olfactory, gustatory and/or esthetic property of these packed products being harmed. Depending on the packed content, the adverse change is manifested in various ways, for example in a change in the appearance, such as yellowing and discoloration, in a change in the taste and/or the smell and/or in the degradation of ingredients. In the case of foods, perfumes and cosmetics products, the shelf life may be greatly reduced. There are often reductions in quality, for example changes in sensory quality, reduced shelf life and/or vitamin losses. In addition, exposure to the effect of light in combination with atmospheric oxygen may lead to the formation of radicals and, as a result, oxidative reactions. Light sensitivity represents a very specific property of the product. The sensitivity to light is additionally increased by ingredients that are particularly sensitive (for example chlorophyll-containing ingredients such as herbs), which must be taken into consideration on a case-by-case basis when packaging such material.

Consumer goods, and foods in particular, are exposed to strong lighting in sales display counters and can thereby suffer considerable harmful effects in terms of quality. On the other hand, the presentation of products under attractive counter lighting increases the inducement to buy. Transparent packaging allows the customer to see the product and thereby increases the impression of quality and/or freshness. Ecological aspects are also driving the trend toward packagings of transparent mono materials. It is therefore not possible to dispense with the use of at least partially transparent containers as a packaging material.

Various types of packaging are known from the sales sector. Customary packaging materials comprise both rigid materials, such as metal or glass, and flexible materials, such as plastics, paperboard etc., as well as all possible combinations thereof. The packagings are either transparent, so that the condition (color, discolorations, nature of the surface, size, piece form, fineness, etc.) of the product can be ascertained as well as possible, or—as in the case of light-sensitive products—of a light-impermeable or dark-colored material. Light-impermeable or dark-colored packagings that protect light-sensitive products from the influence of light have the disadvantage that the product cannot be visually assessed before the packaging is opened. Alternatively, partially transparent packaging materials of plastic, which are replacing the traditional packaging materials such as for example tinplate (light-impermeable) or glass (transparent), are also used in packaging systems for light-sensitive consumer goods. In this case, although the light-sensitive product is exposed less than in completely transparent packagings, a light-sensitive product is nevertheless not protected sufficiently from the influence of light.

There is consequently a demand for packagings which on the one hand protect the packaged products effectively from the harmful influence of light and on the other hand allow visual assessment of the product.

Irrespective of whether or not a product is light-sensitive, an opaque packaging arouses curiosity concerning the content thereof. This applies in particular to packagings of a visually high-class design for expensive consumer goods and luxury items, such as jewellery, high-value entertainment electronics, etc. Here, a packaging that first requires a control intervention by the consumer to gain a glimpse of the packaged item can be a decisive argument in favor of purchasing the product. There is consequently also a demand for packagings which are suitable for bringing about an increase in the inducement to buy on the part of the consumer.

Optically active elements are known from the field of glasses and lenses, or spectacles and window systems. The switching effect is already integrated in the glazing. A distinction is drawn here between the following principles:
thermochromic: coloration brought about by a change in temperature,
thermotropic: opacity brought about by a change in temperature,
photochromic: coloration (darkening) under the influence of light,
electrochromic: coloration brought about by electric current, and
photoelectrochromic: activated electrochromic switching under the influence of light.

Photochromic lenses or plastic plates are used, for example, in self-tinting sunglasses. Under the incidence of sunlight, these lenses darken, but remain translucent (i.e. when illuminated with sunlight the transmission in the visible spectral range diminishes). This effect is generally caused by UV light or shortwave visible light, for example reversible transformations of silver halides incorporated in the glass or of organic layers applied to the plastic plates occur. Photochromic lenses may also be produced on the principle of a dye-sensitized solar cell. The photochromic lens may then be based for example on a multilayer system comprising a catalytic platinum layer as well as a nanoporous WO₃ layer and a nanoporous TiO₂ layer, which are applied to a glass substrate. The pores comprise an electrolyte with positive lithium ions and negative iodide ions. On the titanium dioxide there are dye molecules, which are excited by the incident light and thereby inject electrons into the tungsten oxide via the TiO₂. At the same time, the lithium ions attach themselves to the WO₃, and the iodide ions give off electrons to the dye molecules. These processes cause the tungsten oxide to be colored blue.

Electrochromic glass uses the property of electrochromic materials to change the passing-through or transmission of light depending on the direct voltage applied. Suitable as electrochromic materials are, for example, organic and inorganic materials that have different absorption properties in different states of oxidation, which can be reversibly switched electrochemically. For example, polyaniline (PANI) is colorless in the reduced state and green in the oxidized state, poly(o-phenylene diamine) (PPD) is colorless in the reduced state and red-brown in the oxidized state. The glass changes color when electrical charges are given off to a microscopically thin coating of an electrochromic material on the surface of the glass. Generally, a direct voltage in the single-digit range of volts is sufficient for the electrochemical charge reversal of the active layer. The weak current activates the electrochromic layer (approximately one micrometer thick), which changes the color. Depending on the intended purpose, voltage may be applied manually or automatically, for instance controlled by sensors which measure the brightness. If the glass is short-circuited or the polarity of the voltage is changed, it becomes colorless again or a change of color takes place. In the case of electrochromic materials, energy is only necessary for the switching. The electrochromic glass consequently only requires current during the coloration phase and when producing complete transparency (or during a color-changing phase). If no voltage is applied, the glass retains the existing state of coloration until current is once again supplied. Application areas for electrochromic materials are, in particular, automatically dimming rearview mirrors in motor vehicles and glazing systems in buildings.

While photochromic systems only react passively to the lighting conditions, photoelectrochromic systems are switchable in their transmission. As in the case of photochromic systems, sunlight provides the energy for changing the color. In the photoelectrochromic layers, the active mechanisms of an electrochromic layer and an electrochemical solar cell are combined. The charge transfer takes place via transparent, electrically conducting layers on glass substrates. The layer is switched via an external circuit: if the external circuit is open, the layer becomes colored under irradiation. If the circuit is closed, the layer loses its color again. This process takes place both under lighting and in the dark, i.e. the transmission can be increased again both under lighting and in the dark.

JP 051451852 A describes a cooling chamber for medical purposes. This chamber has a window, through which the interior can be viewed. The window comprises two substrate plates with liquid crystals, which can be supplied with current via transparent electrodes. By actuating an electromechanical sensor, the circuit can be closed, whereby the window, which in the currentless state is opaque milky-white, becomes transparent. A disadvantage of this system is that a control intervention is always absolutely necessary in order to change the light transmission properties of the window. Configuration as a self-regulating system, for example controlling the light transmission in dependence on the external light conditions is not possible. Moreover, a conventional current source is always absolutely necessary. One effect of this is that it makes miniaturization of the system more difficult, and consequently makes it more difficult to use in packagings.

It is an object of the present invention to provide a device which is advantageously suitable for containers and especially packagings, at the same time effectively protects products from the influence of excessive light and allows visual assessment of the product. It is a further object of the present invention to provide a device which is suitable for containers and especially packagings and induces in a consumer the desire to buy.

It has surprisingly been found that an electro-optically switchable system which comprises a momentary switch based on a photovoltaic effect in combination with an optically active element is advantageously suitable for achieving this object. Specifically used for this is an optically active element which, in the illuminated state, at least partially prevents the transmission of light in the visible wavelength range and, by switching an electric circuit, allows an increased transmission of light in the visible wavelength range. This electro-optically switchable system can be advantageously combined with a large number of different packaging materials in order to provide novel containers which effectively protect products contained therein from the influence of excessive light, allow a visual assessment of the product without requiring opening of the container and induce in the consumers the desire to buy. Specifically, configuration as a “self-switching” system is made possible, the device automatically assuming a darkened state when the amount of light impinging on it exceeds a specific limit value. No further intervention on the part of the user is then required, for example to protect the content of a packaging. Even after a control intervention that leads to an increase in the light transmission into the interior of the device, for example in order to view the content of a packaging, the device automatically returns to a safe state.

A first subject matter of the present invention is therefore an electro-optically switchable system which comprises an optically active element which, in the illuminated state, at least partially prevents the transmission of light in the visible wavelength range and, by switching an electric circuit, allows increased transmission of light in the visible wavelength range, and a momentary switch based on a photovoltaic effect, which increases the transmission of light for the duration of the actuation of the momentary switch, it being possible for the transmission of light to be increased by actuating the momentary switch substantially independently of the external illuminated state of the system.

A further subject matter of the invention is a container which comprises such an electro-optically switchable system.

A further subject matter of the invention is the use of such an electro-optically switchable system as a component of a container which allows an increased transmission of light into its interior for the duration of the actuation of the momentary switch.

A further subject matter of the invention is the use of such an electro-optically switchable system as a component of a container for substances which are to be kept protected from the influence of light.

A further subject matter of the invention is the use of a container which comprises such an electro-optically switchable system as packaging for the protection of products packed therein from the harmful effects of light.

A further subject matter of the invention is the use of a container which comprises such an electro-optically switchable system as packaging for increasing the inducement to buy in a consumer.

The electro-optically switchable system according to the invention, which comprises a momentary switch based on a photovoltaic effect in combination with an optically active element, has at least one of the following advantages:
optimum product protection, since the electro-optically switchable system can be designed such that the transmission of light is prevented without a switching intervention,
possibility of configuring a “self-switching” system; the device automatically assumes a darkened state when the amount of light impinging on it exceeds a specific limit value,
if a solar cell is used as the momentary switch, it can at the same time serve as a voltage source for the optically active element; by contrast with conventional electromechanical sensors, this optionally makes it possible to dispense with an external voltage source,
if a solar cell is used as the momentary switch, it can at the same time serve as a sensor for the impinging amount of light, for example to make it possible for the device to darken automatically,
if a photoelectrochromic system is used, the same function as a combination of a solar cell and an optically active element can be realized in one component,
suitable also for small containers,
suitable also for containers with a curved surface,
if suitable optically active elements are used, for example based on liquid crystals, they can at the same time serve as a display (LCD); this makes it possible to impart information visually, for example to provide details about products or show promotional advertisements,
more effective inducement to buy.

Light in the visible wavelength range is understood within the scope of the invention as meaning a wavelength range from 400 to 800 nm. Of course, the electro-optically switchable system according to the invention may, if desired, additionally prevent at least partially the transmission of light in other wavelength ranges. For this purpose, a combination with conventional stabilizers or stabilizer compositions is also possible. These preferably include inorganic pigments, preferably white pigments, specifically titanium dioxide. The electro-optically switchable system according to the invention may additionally have at least one further component selected from antioxidants, light stabilizers, metal deactivators, etc. and mixtures thereof. Suitable antioxidants, light stabilizers and metal deactivators are, for example, selected from: 4,4-diaryl butadienes, cinnamates, benzotriazoles, hydroxy benzophenones, diphenyl cyanoacrylates, oxamides (oxalamides), 2-phenyl-1,3,5-triazines, antioxidants, nickel compounds, sterically hindered amines (HALS), metal deactivators, phosphites and phosphonites, hydroxylamines, nitrones, amine oxides, benzofuranones, indolinones, thiosynergists, peroxide-destroying compounds and mixtures thereof. Suitable stabilizers and stabilizer compositions are commercially available, for example under the name Uvinul® from BASF SE.

“Electro-optically switchable” is understood within the scope of the present invention as meaning that the transmissibility with respect to light in the visible wavelength range can be changed by means of a switching operation. The switching operation in this case combines electrical/electronic and optical effects, for example by conversion of light into electrical energy.

An optically active element is understood within the scope of the present invention as meaning a sheet-like component which has at least two states: one with high light transmissibility and one with low light transmissibility. Suitable are elements which have at least one optically active material. The term optically active material thereby refers to a material which can be transferred reversibly from a state of high light transmissibility to a state of low light transmissibility.

In a suitable embodiment, the optically active element has a layered form of construction, at least one of the layers having at least one optically active material. The element may also have two or more than two optically active materials that are different from one another in a layer, the same optically active material in two or more than two layers arranged separately from one another, two or more than two optically active materials that are different from one another in respectively one or two or more than two layers arranged separately from one another.

An optically active element according to the invention is changeable in its light transmissibility. The term “light transmissibility” is not restricted within the scope of the invention to the “translucence” and is not considered as a delimitation from “transparency” (in the sense of transparency=allowing images through or able to be seen through). Accordingly, the change in the light transmissibility can be achieved according to the invention by coloration/decoloration or opacity/removal of opacity.

By actuating/not actuating the momentary switch, the light transmissibility of the optically active element is increased/reduced. This does not necessarily mean that, when the momentary switch is actuated, the optically active element has complete light transmissibility, but instead it also comprises states in which opacities or colorations prevent part of the visible light from passing through. Similarly, when the momentary switch is not actuated, the optically active element is not necessarily prevented completely from allowing visible light to pass through. If the momentary switch is not actuated, it is merely that opacities or colorations prevent a larger proportion of the visible light from passing through than when the momentary switch is actuated.

In a first preferred variant of the electro-optically switchable system, when a voltage is applied, the optically active element at least partially prevents the transmission of light in the visible wavelength range and, by interrupting the electric circuit, allows an increased transmission of light in the visible wavelength range.

In a second preferred variant of the electro-optically switchable system, when a voltage is not applied, the optically active element at least partially prevents the transmission of light in the visible wavelength range and, by closing the electric circuit, allows an increased transmission of light in the visible wavelength range.

An illuminated state is understood within the scope of the invention as meaning that light in the visible wavelength range impinges on the optically active element.

An increase in the transmission of light is understood as meaning an increase in the transmission of the light in the visible wavelength range which is allowed to pass through. Preferably, actuating the momentary switch has the effect of increasing the transmission by at least 5%, particularly preferably at least 10%, in particular at least 15%, specifically at least 20%, more specifically at least 25%.

When the momentary switch is not actuated, the optically active element preferably has in the illuminated state a transmission of at most 50%, particularly preferably of at most 40% and in particular at most 20%, with respect to the light of the entire visible wavelength range impinging on the optically active element from the outside.

When the momentary switch is actuated, the optically active element preferably has in the illuminated state a transmission of at least 60%, particularly preferably of at least 70% and in particular of at least 80%, with respect to the light of the entire visible wavelength range impinging on the optically active element from the outside.

The switching of the electric circuit may be, for example, a closing or interruption of the circuit.

A momentary switch is understood as meaning an operator control element which is actuated by being pressed or approached and then reverts to the initial position. Unlike in the case of a switch, which remains in the respective position, it cannot be seen from the momentary switch itself whether it has been actuated; that is only evident from the effect initiated. A momentary switch has only the two possible switching states “on” and “off”.

A switch based on a photovoltaic effect is a switch of which the switching states depend on the light intensity accepted by it. In this case there is a limit value for the light intensity accepted, also referred to as the threshold value, below which the switching state is “off” and when reached or above which the switching state is “on”.

“Substantially independently of the external illuminated state” means that the intensity of the light impinging on the optically active element from the outside is generally irrelevant. Only if the intensity of the light impinging on the optically active element from the outside goes below the threshold value of the momentary switch is the transmission of the optically active element switched without intervention on the part of an operator. However, this is generally not critical, since the amount of light passing through the optical element in this case is only very small. Consequently, for example when the electro-optically switchable system is used in a packaging for materials which are to be protected from the influence of light, any harm can generally be ruled out.

In a preferred embodiment of the electro-optically switchable system according to the invention, the momentary switch comprises a solar cell or consists of a solar cell.

A solar cell or a photovoltaic cell is an electrical component which converts the radiant energy comprised in the light directly into electrical energy.

If the solar cell is darkened below a threshold value, the generation of current is interrupted. The solar cell therefore assumes the function of a momentary switch, since switching in dependence on the light intensity is desired. In the present case, the solar cell is switched such that, below a predetermined limit value or threshold value for the incident amount of light or light intensity, it no longer gives off current. This threshold value is chosen such that a slight reduction in the incident amount of light or light intensity, for example a shadow falling over the solar cell, is not sufficient to interrupt the current flow. The current flow is only interrupted by the deliberate darkening of the cell, for example by a thumb, a hand or an object. In this way, the light transmissibility of the optically active element is controlled by a deliberate intervention.

According to the first variant, described above, of the electro-optically switchable system according to the invention, when a voltage is applied, the optically active element at least partially prevents the transmission of light in the visible wavelength range and, by interrupting the electric circuit, allows an increased transmission of light in the visible wavelength range.

If, in this switching arrangement, the circuit is closed when there is incident light, the light transmissibility of the optically active element is reduced, whereby the optically active element colors. By actuating the momentary switch (for example darkening of a solar cell below a threshold value), the circuit is interrupted and the light transmissibility of the optically active element is increased—substantially independently of the external illuminated state.

The switching states according to this first variant can be summarized as follows:

| | | Optically active | | |
|---|---|---|---|---|
| Switch | Current | element | Content | |
| off | on | colored | not visible | protected |
| on | off | transparent | visible | not protected |

In a specific embodiment of the first variant, the momentary switch comprises a solar cell or consists of a solar cell. This embodiment makes it possible to provide an electro-optically switchable system according to the invention which does not have any further current source in addition to the solar cell. Consequently, by contrast with conventional systems based on an electromechanical sensor, this makes it possible to dispense with at least one component. Furthermore, the use of a solar cell makes configuration as a “self-switching” system possible, i.e. the device automatically assumes a darkened state when the amount of light impinging on it exceeds a specific limit value. With completely dark surroundings below a fixed threshold value, the circuit is interrupted, and the light transmissibility of the optically active element is increased.

The switching states according to the first variant when a solar cell is used can be summarized as follows:

| | | Optically active | | |
|---|---|---|---|---|
| Solar cell | Current | element | Content | |
| on | on | colored | not visible | protected |
| off | off | transparent | visible | not protected |

In a preferred embodiment of the electro-optically switchable system according to the invention, the optically active element comprises liquid crystals. Preferably, the optically active element comprises at least two liquid-crystalline layers which have the same chirality and absorb in a similar wavelength range. Particularly preferably, the optically active element comprises at least two chiral-nematic layers which have the same chirality and absorb in a similar wavelength range.

Suitable in principle are liquid crystals and switching arrangements such as are used in known LCDs (liquid crystal displays). These include devices based on simple liquid crystal cells, for example on the principle of the Schadt-Helfrich cell. These are nematic cells (twisted nematic, TN), which comprise two conductive transparent substrates between which the liquid crystals are located. The privileged directions of the two substrate plates are in this case twisted by 90° with respect to one another. Also suitable are devices based on STN (super twisted nematic) cells. Here, the angle of twist lies in a range from 180 to 270°. Also suitable are devices based on cholesteric LCDs.

The electro-optically switchable system according to the invention may be produced analogously to conventional LCDs that are based on inflexible substrates. These systems are suitable specifically for use in containers which have at least one planar surface. The electro-optically switchable system according to the invention may, furthermore, be produced analogously to LCDs which are based on flexible substrates. This is a preferred embodiment of the invention. Electro-optical systems based on liquid crystals on flexible substrates are suitable for use in a large number of different containers and specifically packagings, such as cardboard boxes, bottles, cans, pouches, bags, etc.

Suitable substrates for organic solar cells are, for example, oxidic materials (such as glass, ceramics, SiO₂, quartz, etc.), polymers (for example polyethylene terephthalate, polyolefins, such as polyethylene and polypropylene, polyesters, fluoropolymers, polyamides, polyurethanes, polyalkyl(meth)acrylates, polystyrene, polyvinyl chloride and mixtures and composites thereof) and combinations thereof.

A material which is at least partially transparent with respect to the incident light is preferably used as electrode material for the substrate facing the viewer. This specifically includes glass and transparent polymers, such as polyethylene terephthalate. The electrical contacting generally takes place by metal layers and/or transparent conductive oxides (TCOs). These preferably include ITO, doped ITO, FTO (fluorine doped tin oxide), AZO (aluminum doped tin oxide), ZnO, TiO₂, Ag, Au and Pt.

With respect to the production of electro-optically switchable systems in which the optically active element comprises liquid crystals, reference is made to the full disclosure of the following documents:

You-Jin Lee et al. describe in Mol. Cryst. Liq. Cryst., Vol. 480, pages 278-283 (2008), the production of mechanically stable flexible LCDs from a polymer LC mixture by phase separation, resulting in so-called pixel-isolated LCs (PILCs) (also see Se-Jin Jang et al. in Jpn. J. Appl. Phys., Vol. 44, No. 9A (2005), pages 6670-6673).

Y.-T. Kim et al. describe in Appl. Phys. Lett. 88, 263501 (2006), pixel-encapsulated flexible displays based on a multifunctional elastomer substrate for self-orienting LCs.

Mol. Cryst. Liq. Cryst., Vol. 470, pages 191-197 (2007) describes stable flexible LCDs by the use of microstructures which serve as spacers between the substrates.

Se-Jin Jang et al. describe in SID International Symposium 2007, Digest of Technical Papers, Volume XXXVIII, Book I, pages 653-656, the firm bond between two plastic substrates for producing flexible LCDs.

Y. Watanabe et al. describe in SID International Symposium 2007, Digest of Technical Papers, Volume XXXVII, Book I, pages 418-419, transparent plastic films with excellent optical properties for flexible LCDs.

Y.-T. Kim et al. describe in 2006 IEEE Leos Annual Meeting Conference Proceedings, Montreal, QC, Canada, pages 424-425, highly flexible LCDs with plastic substrates for mobile applications.

T Schneider et al. describe in Proc. of SPIE Vol. 6487, 64870J, (2007), flexible cholesteric LCDs.

In a further preferred embodiment of the electro-optically switchable system according to the invention, the optically active element comprises polymer-dispersed liquid crystals (PDLCs). Polymer-dispersed liquid crystals generally require when switching a voltage in a range from approximately 10 to 20 V. They are advantageously distinguished by being easy to produce. They are suitable in particular for use in fixedly installed devices, for example sales display counters and presentation cabinets. The production of PDLCs is described, for example, by T. Kajiyama et al. in the Annual Report of the Faculty of Engineering, Kyush (2003), “Development of Flexible and Large-area Liquid Crystal Display Devices”, pages 19-28.

With a polymer-dispersed liquid crystal element (PDLC element), it is possible to change the transparent nature of the element by applying an electrical voltage. The functional principle of a PDLC element is based on an optically active material which consists of tiny liquid crystal droplets dispersed within a solid polymeric material. This material, also referred to as LC film, is located between two conductively coated plastic films. These lie within a laminar structure of plates or films and provide the current flow. Without an electrical voltage, the liquid crystals contained in the polymer are randomly oriented, and the incident light is scattered. The liquid crystals thereby form a milky-opaque surface, which serves as an effective concealment or as a protection from incident light. If an electrical voltage is applied, the liquid crystals take on the same orientation, and the layer becomes clear. Very high transparency is only achieved, however, when it is viewed perpendicularly to the layer. If the incidence of light or the viewing angle is oblique, a slight scattering of light can be observed even with electrical voltage.

The state described is a “Normally Black Mode”. However, by appropriate arrangement of the film or a number of LC films, a “Normally White Mode” can be set up. In this case, the light passes through in the switched-off state. Only by applying a voltage can the PDLC element be made opaque or protection from light obtained. Alternatively, an element in the “Normally Black Mode” can be put into a mode which corresponds to a “Normally White Mode” by suitable electrical switching.

According to the second variant, described above, of the electro-optically switchable system, when a voltage is not applied, the optically active element at least partially prevents the transmission of light in the visible wavelength range and, by closing the electrical circuit, allows an increased transmission of light in the visible wavelength range.

In this embodiment, the optically active element is preferably a photoelectrochromic element, which, in the non-switched state, becomes darkly colored under lighting and, by closing the electric circuit, becomes substantially transparent, independently of the external illuminated state of the system. A photoelectrochromic element combines the active mechanisms of an electrochromic layer and an electrochemical solar cell. The charge transfer takes place via transparent, electrically conducting layers on glass substrates. The layer is switched via an external circuit: if the external circuit is open under irradiation, the layer becomes colored. If the circuit is closed, the layer loses its color, even under irradiation. The coloration is maintained as long as the switch remains open.

In a preferred configuration of the second variant, the momentary switch comprises a photodiode or consists of a photodiode. It is also possible in this embodiment that the momentary switch comprises a solar cell or consists of a solar cell. However, the use of a solar cell is not as advantageous in all aspects as in the first variant, since, during switching (switch on), the electric circuit is closed in order thereby at least to prevent the transmission of light. If the solar cell is darkened for switching, it is not available as a current source, so that, according to the second variant, a conventional current source is generally required even when a solar cell is used as the momentary switch.

Photodiodes are semiconductor diodes which convert visible light into an electric current. They are used in light barriers, remote controls with infrared radiation (remote operator controls) and in light measurement. They are used in optical transmission systems and in solar cells. In the present invention, a photodiode is used to convert light into a voltage signal.

The switching states according to the second variant using a photodiode can be summarized as follows:

| | | | Optically active | | |
|---|---|---|---|---|---|
| Photodiode | Switch | Current | element | Content | |
| on | off | off | darkly colored | not visible | protected |
| off | on | on | transparent | visible | not protected |

This means:
When there is incident light or in bright surroundings, the optically active element darkly colors.
In dark surroundings, the optically active element loses its color and becomes transparent.
When the photodiode (or alternatively a solar cell) is darkened completely (sensor function, switch on), the optically active element becomes transparent, independently of the external illuminated state.

The subject matter of the present invention is likewise a packaging which comprises an electro-optically switchable system according to the invention.

A packaging is understood as meaning the deliberately applied, releasable wrapping of a product. Some products such as bulk goods, liquids or gases are packed in containers. Suitable packagings are, for example, bags, bottles, tubes, buckets, crates, cartons, cardboard boxes or cans. Suitable materials for packagings are, for example, paper, plastic, wood, metal, tinplate, glass, paperboard, etc.

In a suitable embodiment, a light source for the momentary switch is additionally provided.

A light source is understood within the scope of the present invention as meaning a place from which light and, in particular light in the visible wavelength range, originates. Here, this is particularly an artificial light source. The light source may be both of the first order and of the second order. Light sources of the first order are self-illuminating light sources. These include lamps, for example. Light sources of the second order is the term used for bodies which only reflect light and do not emit light themselves. These include, for example, reflectors on vehicles and clothing and all other bodies which reflect light. The light source may be a point light source, a diffuse light source or a combination thereof.

The provision of a light source for the momentary switch is intended to ensure that the external illuminated state of the momentary switch is always the same. This allows the electric circuit to be switched completely independently of the illuminating state of the surroundings.

In a preferred embodiment, the packaging according to the invention is used for sales products which are to be protected from the influence of light.

Sales products are understood as meaning consumer goods which are produced and traded for private use or consumption. They may be durable goods, which are not consumed in the actual sense but are subject to wear (abrasion) through repeated use, and in particular consumer goods, such as for example foods, medicines, body care products, etc. Sales products may be goods for everyday needs (“convenience goods”), that is to say normally goods with a comparatively low price, or goods purchased by seeking and comparing (“shopping goods”), that is to say goods with a higher price than goods for everyday needs, or special products and specialties (“specialty goods”), that is to say luxury items with a comparatively very high price.

When purchasing these goods or sales products, comparisons are made in the course of the purchasing decision to select the best possible alternative. Such sales products are often kept protected from the influence of light, in order to preserve the quality over as long a period of time as possible.

In sales, the packaging may assume not only a protective, storing, loading and transporting, dosing and removal function. As sales packaging, it may also serve as an aid for rationalizing the selling process or optionally as sales packaging with additional benefits. Furthermore, it may perform a selling and/or advertising function by its geometrical or color-related design and/or as a carrier of informative text and images. The purchaser can recognize the product from the sales packaging, whether by the name, the logo, the color or the form of packaging. It additionally has an informational function. The packaging identifies the product according to type, quantity, weight and price, informs by providing warnings about hazardous products, use-by dates and intended use, and is also a carrier of encoded data (barcodes). For example, the printed-on EAN code allows rapid reading-in at scanner checkouts.

An attractive sales packaging boosts sales, thereby increases sales revenue, and gains new customers. The sales packaging often gives the first impression, which is decisive for making a purchase.

A further subject matter of the present invention is the use of the electro-optically switchable system according to the invention in a container for substances which are to be kept protected from the influence of light.

Specifically, the electro-optically switchable system according to the invention is used in packaging for sales products which are to be kept protected from the influence of light.

In particular, the sales products concerned in the use according to the invention of the electro-optically switchable system are light-sensitive foods, drugs, cosmetic items or tobacco or tobacco products.

Foods are understood here as substances or products which are taken orally by people for the purpose of nutrition and/or pleasure. They are optionally prepared in advance. Foods comprise, in particular, foodstuffs, semi-luxury items and food supplements as well as food additives. The foods may be products of plant origin, such as for example vegetables, fruit, pulses, nuts, fungi, (dry) cereal products, vegetable edible oils and fats, confectionery, coffee, tea, cocoa, herbs and spices, or products of animal origin, such as for example dairy products, but also water, salt, beverages or further-processed products, such as for example convenience products.

A large number of products for sale are sensitive to light, i.e. there is a high photo-chemical risk for these products or their contents. Important possible influences for a product, in particular a food, to suffer light damage are:
the intensity (total energy) of the light impinging on the food,
the color of the impinging light (spectral energy distribution),
the time the food stays in the light,
the simultaneous presence of light and oxygen,
the temperature,
the composition of the product:
   light absorption behavior of the product,
   contents at risk,
   possible types of reaction of the ingredients,
   presence of sensitizers and inhibitors.

In the case of a light-induced reaction, what matters primarily is not the light to which the food is exposed but the proportion of light that is absorbed, i.e. the energy taken up. The following processes by which foods can be damaged by light may occur individually, in parallel, in intensifying unison, in competition or as a consequential reaction:
light-induced autooxidation of unsaturated fats,
photosensitized oxidation (photooxidation) of fats and proteins,
photosensitized oxidation of dyes,
decomposition of dyes by the influence of light.

For example, the sensitivity of edible oils to light-induced reactions with oxygen (photo-oxidation) is known. Photolytic processes in milk and dairy products may lead to light-induced aroma defects, such as for example the formation of a sebaceous-rancid taste, known as the “light taste”, and a light-induced vitamin reduction (loss of ascorbic acid). Cocoa butter is oxidation-sensitive under the influence of light. In particular, white chocolates, milk chocolates and chocolates with added ingredients such as nuts, for example, are therefore particularly sensitive to light. In the case of chlorophyll-containing plant ingredients, a fat oxidation may be initiated under the effect of light. In the case of meat or fish, the presence of hematin compounds may be conducive to autooxidation. In the case of fleshy meat, light may be conducive to the formation of metmyoglobin (changing the color from red to gray). Ground paprika loses its color, for example, under the influence of light. However, paprika is only perceived by the consumer as a high-quality product by an intensive color. Even frozen goods are sensitive to light: the red coloration of frozen beef is only preserved for about three days under lighting, whereas in the dark it is preserved for three months.

Usually, such light-sensitive products are therefore sold in lightproof packagings, for example bags, boxes, etc. However, lightproof packagings do not allow the interior of the packaging, and consequently the product, to be viewed. This is disadvantageous in particular whenever the potential purchaser would like to assess the quality of the product him/herself from its appearance. The external nature of the product, such as for example the graininess or fineness, for example in the case of ground products, the color, for example in the case of spices, etc., are often used as a criterion for quality, in particular of highly priced foods. In order for the potential purchaser to be able to assess the appearance of the product, a packaging must therefore allow visual assessment of the product.

Purchasing decisions are mostly made subconsciously on an emotional basis. Subconscious inducements generally lead quickly and directly to a decision to purchase. In this respect, the special character of a product (new, improved, fresh, exclusive, etc.) plays a decisive role, since it arouses curiosity and interest in the product. Playing with expectations and the yearning for the fantastic, that is to say even packagings that appeal to the play instinct, are on an upward trend. Design has become the key element in all areas of the consumer world and is regarded as an additional product advantage. Not least, design serves as a key for product differentiation. After all, it is no longer sufficient simply to package the product. The packaging must reflect the advantages and values of a product.

The novel packaging therefore not only allows the potential purchaser to make a subjective assessment of the quality of the product but also allows the product nevertheless to be protected from the harmful influence of light. What is more, an appropriate design of the novel packaging can additionally initiate in the customer an inducement to buy.

The electro-optically switchable system according to the invention, and specifically a packaging according to the invention, substantially comprises two components: an optically active element and a momentary switch based on a photovoltaic effect, the momentary switch preferably comprising a solar cell or consisting of a solar cell. The generation of current preferably takes place by incidence of light on the solar cell, which may be, for example, flexible, rigid, (poly)crystalline or dye-based. For the technical realization of a device according to the invention, commercially available components may be used.

Polycrystalline solar cells are standard articles and can be obtained, for example, from Conrad Electronics. These include solar cells with the name “SOLAR-ZELLE 5 V/81 MA” (http://www.conrad.de/ce/de/product/191321/SOLARZELLE-5-V81MA, April 2010). These have a rated voltage of 5 V.

Dye solar cells may be obtained, for example, from the company G21i, Cardiff, Wales (www.g24i.com, April 2010). In one particular embodiment, these are flexible, and consequently suitable for use on curved surfaces.

An LCD unit suitable for self-darkening can be obtained, for example, from the company Nemoptic (1, rue Guynemer, 78114 Magny les Hameaux, France, www.nemoptic.com, April 2010) or from the company Densitron (www.densitron.com, April 2010; article LMR37338)). This is a flexible, transmissive LCD unit, which, depending on the voltage state, can be switched between transparent and black. Depending on the LCD type, the switching voltage to be used in this case lies between 3 and 5 V. A grid of so-called dots is sufficient, so that no further control electronics have to be used. An exception to this is of course applications in which imaging is desired (for example for advertising purposes).

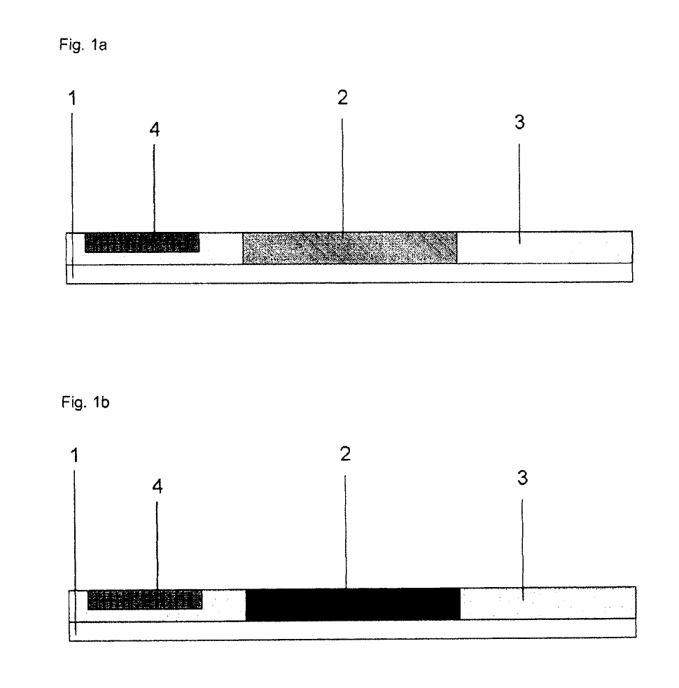

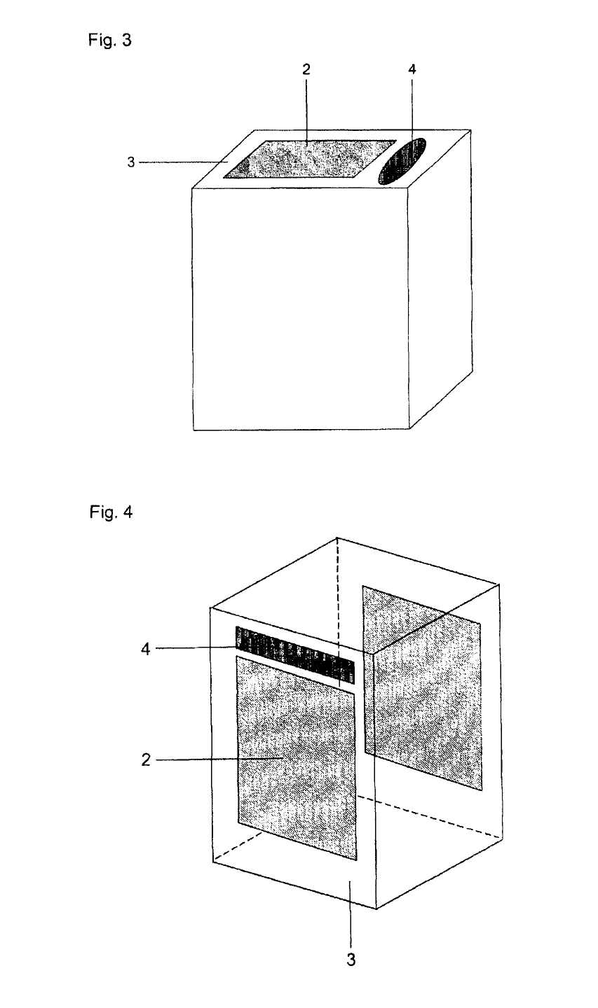

FIGS. 1a and 1b as well as 2a and 2b respectively represent a possible embodiment of an electro-optically switchable system according to the invention. In FIGS. 3 to 6, possible uses of the electro-optically switchable system according to the invention in containers, more specifically in packagings, are represented. These figures are intended to explain the present invention, without restricting it to the figures.

In FIGS. 1a to 2b and 3 to 6, the following reference numerals are used:

1=transparent film or wall,

2=optically active element,

3=light-impermeable film or wall,

4=solar cell.

In FIGS. 1a and 1b, a simple embodiment of the electro-optically switchable system according to the invention is represented. The optically active element 2 and the solar cell 4 are located on a transparent film or wall 1, which serves as a carrier. On this carrier, they are embedded in a light-impermeable film or wall 3. Thus, visible light can only penetrate through the system in the region of the optically active element.

In FIG. 1a, the solar cell 4 is covered from above (darkened), that is to say not exposed to the light (incident from above, not represented). In this case, the optically active element 2 is transparent. Light can therefore pass through the optically active element 2 in the direction of impingement (from above downward, not represented).

If the solar cell is not covered from above, that is to say is exposed to the light (incident from above, not represented), as shown in FIG. 1b, the optically active element becomes substantially impermeable to light.

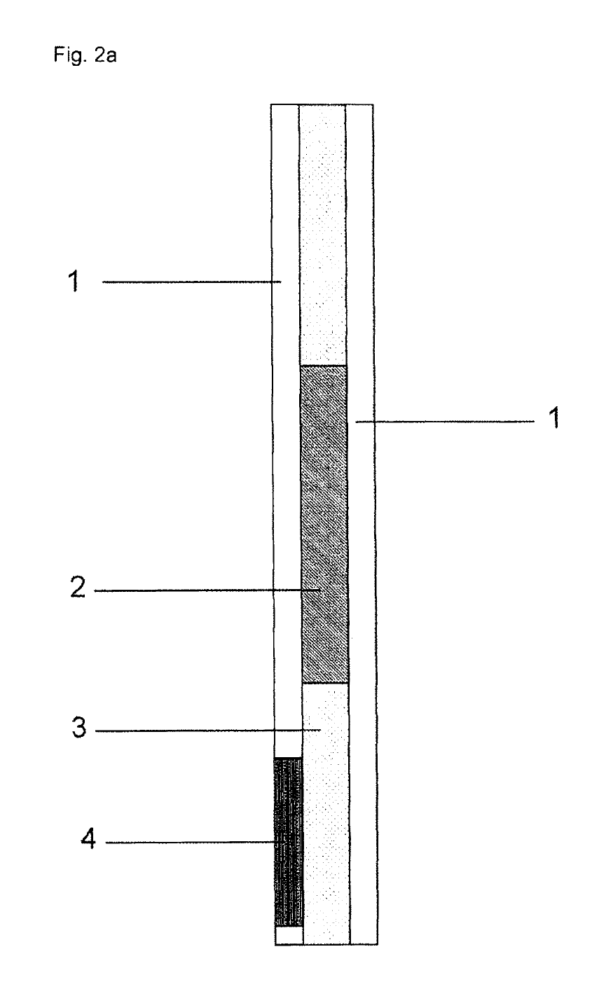

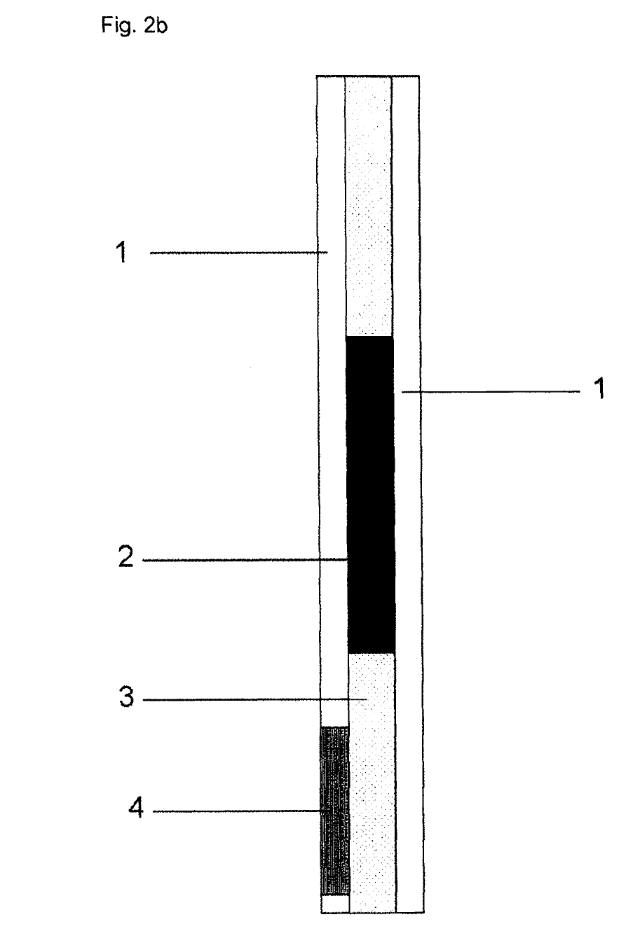

In FIGS. 2a and 2b, a second embodiment of the electro-optically switchable system according to the invention is represented. The optically active element 2 is located on a transparent film or wall 1, which serves as a carrier. On this carrier, it is embedded in a light-impermeable film or wall 3. The solar cell 4 is embedded in a further transparent film or wall 1. This second transparent film or wall 1 completely covers the light-impermeable film or wall 3 and the optically active element 2. In this arrangement, too, visible light can only penetrate through the system in the region of the optically active element.

In FIG. 2a, the solar cell 4 is covered from the left, that is to say is not exposed to the light (incident from the left, not represented). In this case, the optically active element 2 is transmissive or permeable to light in the visible wavelength range. Light can therefore pass through the optically active element 2 in the direction of impingement (from the left to the right, not represented).

If the solar cell is not covered from the left, that is to say exposed to the light (incident from the left, not represented), as shown in FIG. 2b, the optically active element is substantially impermeable to light.

The embodiments represented in FIGS. 1a to 2b are suitable for rigid or flexible optically active elements. They may be constructed on rigid or flexible and flat or bent surfaces. A viewing window formed in such a way can be made in various sizes, through to a banderole or even a complete sleeve. Substances behind the window or inside the container are thus effectively protected from the influence of light.

The embodiment represented in FIGS. 2a and 2b is suitable in a particular way for use in a “TetraPak©” multilayer packaging. Here, too, the viewing window may be made in various sizes, through to a banderole or even a complete sleeve.

In FIGS. 3 to 6, a possible configuration of a packaging with a novel electro-optically switchable system integrated therein is respectively represented.

FIG. 3 shows a cuboidal container with a switchable viewing window. The viewing window substantially comprises an optically active element 2 and can be switched between transparent and light-impermeable by means of a solar cell 4. The container itself consists of light-impermeable walls 3. The optically active element and the solar cell are arranged on one side of the cuboid a small spatial distance apart.

The arrangement in FIG. 3 allows a view of the product located in the container.

FIG. 4 likewise shows a cuboidal container, but with two opposing switchable viewing windows. The viewing windows substantially comprise an optically active element 2 in each case and can be switched at the same time between transparent and light-impermeable by means of a solar cell 4. The container itself consists of light-impermeable walls 3. The solar cell and an optically active element are arranged on one side of the cuboid a small spatial distance apart.

The arrangement in FIG. 4 allows a view through the container, and consequently a more comprehensive assessment of the product located therein.

The configuration shown in FIGS. 3 and 4 is suitable in particular for rigid or not readily deformable packagings, such as for example pill containers. Use for a refrigerator door is also possible.

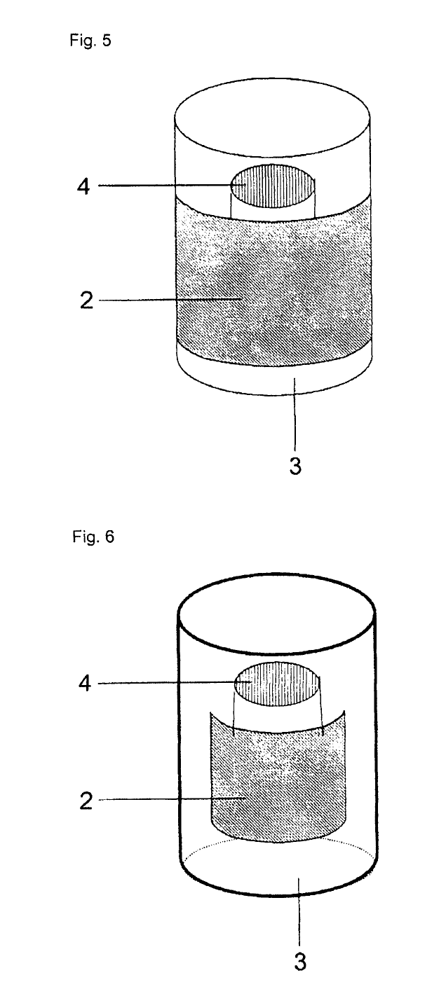

FIG. 5 shows a cylindrical container with a switchable viewing window. The viewing window substantially comprises an optically active element 2 and can be switched between transparent and light-impermeable by means of a solar cell 4. The container itself consists of light-impermeable walls 3. The viewing window or the optically active element goes completely around the cylindrical surface in the form of a banderole.

The arrangement in FIG. 5 allows a view through the container, and consequently an all-round assessment of the product located therein.

FIG. 6 likewise shows a cylindrical container with a switchable viewing window, comparable to FIG. 5. However, the viewing window or the optically active element only takes up one segment of the cylindrical surface.

The arrangement in FIG. 6 allows a view of the product located in the container.

The configuration shown in FIGS. 5 and 6 is suitable in particular for cans or bottles.

In addition, a solution comprising a fully flexible film is possible. In a way similar to that represented in FIGS. 3 and 4, but with a very small extent in one spatial direction, a pouch or bag can be obtained by using a flexible film. The optically active element may then be designed as a slip-in light cover.

1. An electro-optically switchable system, comprising
an optically active element which, in the illuminated state, at least partially prevents the transmission of light in the visible wavelength range and, by switching an electric circuit, allows increased transmission of light in the visible wavelength range, and
a momentary switch based on a photovoltaic effect, which increases the transmission of light for the duration of the actuation of the momentary switch,
it being possible for the transmission of light to be increased by actuating the momentary switch substantially independently of the external illuminated state of the system.

2. The electro-optically switchable system according to claim 1, wherein the momentary switch comprises a solar cell or consists of a solar cell.

3. The electro-optically switchable system according to claim 1, wherein, when a voltage is applied, the optically active element at least partially prevents the transmission of light in the visible wavelength range and, by interrupting the electric circuit, allows an increased transmission of light in the visible wavelength range.

4. The electro-optically switchable system according to claim 3, wherein the optically active element comprises liquid crystals.

5. The electro-optically switchable system according to claim 4, wherein the optically active element comprises at least two liquid-crystalline layers which have the same chirality and absorb in a similar wavelength range.

6. The electro-optically switchable system according to claim 5, wherein the optically active element comprises at least two chiral-nematic layers which have the same chirality and absorb in a similar wavelength range.

7. The electro-optically switchable system according to claim 4, wherein the optically active element comprises polymer-dispersed liquid crystals.

8. The electro-optically switchable system according to claim 1, wherein, when a voltage is not applied, the optically active element at least partially prevents the transmission of light in the visible wavelength range and, by closing the electrical circuit, allows an increased transmission of light in the visible wavelength range.

9. The electro-optically switchable system according to claim 8, wherein the optically active element is a photoelectrochromic element, which becomes darkly colored under lighting and, by closing the electric circuit, becomes substantially transparent, independently of the external illuminated state of the system.

10. The electro-optically switchable system according to claim 9, wherein the momentary switch comprises a photodiode or consists of a photodiode.

11. A container, which comprises an electro-optically switchable system according to claim 1.

12. The container according to claim 11, wherein a light source for the momentary switch is additionally provided.

13. The container according to claim 11 for sales products which are to be protected from the influence of light.

14. The use of an electro-optically switchable system as defined in claim 1 as a component of a container which allows an increased transmission of light into its interior for the duration of the actuation of the momentary switch.

15. The use of the electro-optically switching system as defined in claim 1 as a component of a container for substances which are to be kept protected from the influence of light.

16. The use according to claim 15 in a packaging for sales products which are to be kept protected from the influence of light.

17. The use according to claim 15, wherein the sales products are foods, food supplements, drugs and/or cosmetics.

18. The use of a container, comprising an electro-optically switchable system as defined in claim 1, as packaging for the protection of products packed therein from the harmful effects of light.

19. The use of a container, comprising an electro-optically switchable system as defined in claim 1, as packaging for increasing the inducement to buy in a consumer.
